(19) United States
(12) Patent Application Publication
(10) Pub. No.: US 2006/0081741 A1
(43) Pub. Date: Apr. 20, 2006

(54) Torque transferring apparatus of disk brake lathe

(76) Inventor: Gwang-Hun Baek, Seoul (KR)

Correspondence Address: DITTHAVONG & CARLSON, P.C., Suite A, 10507 Braddock Road, Fairfax, VA, 22032, US

(21) Appl. No.: 10/966,184

(22) Filed: Oct. 15, 2004

(51) Int. Cl. F16M 11/00

(52) U.S. Cl. 248/200

(57) ABSTRACT

A torque transferring apparatus of a disk brake lathe includes: an adaptor installed in a rotational shaft of a driving device, for transferring a torque from the driving device to a brake disk mounted on a vehicle; and a bracket coupled to the adaptor so that the bracket is coupled to a bolt of the brake disk side, the bracket including a flexible rod 8 inserted into a groove of the adaptor, a coupling panel coupled to the disk, and a coupling rod horizontally coupled spaced apart from the coupling panel. A coupling panel is coupled to the disk, and an integral bracket provides a separation position from the coupling panel. An adaptor is coupled to the bracket, such that the adaptor is horizontally spaced apart from the coupling panel. The adaptor has a groove. A flexible rod is coupled between the adaptor and the rotational shaft, such that a torque is transferred from the rotational shaft. The bracket includes a reinforcement rib at a bent portion between the separation panel and the coupling panel, and a bent portion between the separation panel and the installation panel. The flexible rod is spline coupled to the insertion groove of the rotational shaft in order to prevent a weight concentration toward the pin.

### BACKGROUND OF THE INVENTION

1. Field of the Invention

The present invention relates to a torque transferring apparatus of a disk brake lathe, and more particularly, to a torque transferring apparatus of a disk brake lathe, in which a bracket coupled to a disk is integrally provided, such that it is mechanically stable and easily manufactured, and parts are conveniently exchanged.

2. Description of the Related Art

In general, a disk brake is provided for performing a braking function by pushing a braking pad at both sides of the brake disk rotating together with a wheel due to a hydraulic pressure.

Since the disk rotates in such a state that it is exposed to air, a heat sinking is well done so that a braking force is stable. Even when the disk is repeatedly used at high speed, there is little change in the braking force and a problem of a partial braking is reduced.

However, since a frictional area between the disk and the pad is small, it is required to increase a force of pushing the pad. Also, the disk may be deformed due to a fatigue weight according to the repeated braking.

Accordingly, in the deformation of the disk, a brake disk lathe which performs a re-process of a flat surface of the disk surface is proposed in order to maintain a contact between the disk surface and the braking pad.

The brake disk lathe includes a driving device for rotating a disk in a state that a brake disk is mounted on a vehicle, and a cutting tool for resurfacing a surface of a brake disk. Such brake disk lathes are disclosed in U.S. Pat. Nos. 5,974,878, 6,626,073, 6,629,479, and 5,549,023 and Korean Utility Model Registration No. 20-0253743.

In more detail, an apparatus for rotating a disk of a conventional brake disk lathe is shown in FIG. 1. Specifically, the apparatus of FIG. 3 is disclosed in Korean Utility Model Registration No. 0253743.

The apparatus includes: a supporter 1 on which a caster with a locker is provided for movement and fixing; a driving device 2 installed on the supporter and using a motor as a power source; an adaptor 4 for transferring a power to one end of a rotational shaft 3; and a bracket 7 inserted into the adaptor 4 such that it is coupled to a bolt 6 formed at a hub shaft of a disk 5.

Here, a flexible rotational shaft is generally used as the rotational shaft 3. The lathing is performed in a state the disk 5 is mounted on a vehicle. It is difficult to accurately match the rotational shaft 3 with a rotational shaft 3′ of the disk relatively fixed in order to rotate the disk 5.

Accordingly, in the arrangement of the apparatus, the flexible rotational shaft 3 is applied to the rotational axis by its distance even when the rotational shaft 3′ of the disk 5 and the rotational shaft 3 of the rotation device are not accurately matched.

Meanwhile, in a coupling device for transferring a power, a coupling means is required at center of the rotational shaft of the driving device and the rotational shaft of the disk.

Also, a coupling means for managing a mismatch between the rotational shaft of the driving device and the rotational shaft of the disk is required.

The adaptor 4 is mounted on a rotational shaft 3, and the flexible rod 8 is inserted into the adaptor 3. The flexible rod 8 is extending flexibly in a radial direction of the rotational shaft. The bracket 7 is mounted on the flexible rod 8. The bracket 7 includes a coupling panel 10 horizontally extended through an U-shaped coupling rod 9.

The coupling panel 10 is coupled to the bolt 6 of the disk 5 through a coupling hole 11 and a wheel nut 12. A groove 13 is formed as an interference member with a hub for 2-point support and is coupled to the wheel nut 12, while avoiding an interference with the hub and arranging the coupling rod 9 toward a center of the rotational shaft to the maximum.

Meanwhile, the adaptor 4 includes a groove 14 into which the flexible rod 8 is inserted in order to manage a linear mismatch on a rotational shaft while interfacing with the flexible rod 8 to transfer a torque. The groove 14 provides a flexible region where there is no interference member in a rotational direction and a lateral direction perpendicular to the axial direction. Also, the groove 14 provides a freedom of the rotation of the flexible rod 8 in a state that the groove 14 contacts with flexible rod 8.

A mismatch of the rotational shaft is classified into a mismatch on a straight line and a twist on a shaft having a declination (refer to FIG. 1C). The flexible rod manages the mismatch on the straight line while sliding in a lateral directional from the groove of the adaptor.

The twist on the shaft is divided into biaxial orientation and is managed by the rotational shaft's rotation and contact in front and rear directions of the opening of the groove. For this purpose, the flexible rod 8 has a circular rod shape.

The flexible rod 8 and the coupling panel 10 are horizontally installed. Accordingly, during the rotation of the driving device, a locus of the flexible rod 8 and a locus of the coupling panel form a horizontal rotational surface. As the coupling panel and the disk are coupled to each other, the horizontal rotational surface coincides with the rotational surface of the disk.

Therefore, the bracket 7 requires the corresponding precision and stiffness.

However, the coupling of the coupling panel 10 and the U-shaped coupling rod 9 and the coupling of the coupling rod 9 and the flexible rod 8 are generally achieved by a welding. The stiffness at the coupling portions is degraded. Also, a horizontal precision is difficult to secure and a mechanical reliability is degraded.

Also, it is troublesome that the coupling panel 10, the U-shaped coupling rod 9 and the flexible rod 8 are separately manufactured and then welded. Thus, it is difficult to secure the productivity.

As a result, the problem is caused by unreasonable structure in which the flexible rod 8 and the coupling panel 10 are provided at the bracket 7 through the U-shaped coupling rod 9 that is provided as another structure.

Also, the horizontal state of the coupling plate and the flexible rod may be twisted due to the fatigue weight. Therefore, the replacement of the bracket due to the deformation of the horizontal state means the entire replacement of the bracket.

Further, the adaptor is a part that repeats friction with the flexible rod in order to manage the mismatch on the rotational shaft. That is, the adaptor must be replaced when the deformation or damage occurs. The installation on the rotational shaft results in the inconvenience of the replacement.

### SUMMARY OF THE INVENTION

An object of the present invention is to provide a torque transferring apparatus of a disk brake lathe, in which a bracket coupled to a disk is integrally provided, such that it can be mechanically stable and easily manufactured, and parts can be conveniently exchanged.

According to an aspect of the present invention, there is provided a torque transferring apparatus of a disk brake lathe including: an adaptor 4 installed in a rotational shaft 3 of a driving device, for transferring a torque from the driving device to a brake disk mounted on a vehicle; and a bracket 7 coupled to the adaptor 4 so that the bracket 7 is coupled to a bolt of the brake disk side, the bracket including a flexible rod 8 inserted into a groove 14 of the adaptor 4, a coupling panel 10 coupled to the disk 5, and a coupling rod 9 horizontally coupled spaced apart from the coupling panel 10, the apparatus comprising: a coupling panel 20 coupled to the disk 5; an integral bracket 26 providing a separation position from the coupling panel 20; an adaptor 28 coupled to the bracket 26, such that the adaptor is horizontally spaced apart from the coupling panel 20, the adaptor 28 having a groove; and a flexible rod 30 coupled between the adaptor 28 and the rotational shaft 3, such that a torque is transferred from the rotational shaft 3.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1A is a view of a conventional disk brake lathe;

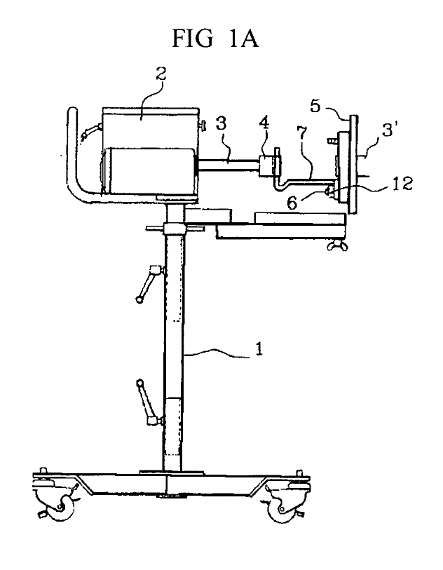

FIG. 1B is a view illustrating a torque transferring apparatus of a conventional disk brake lathe;

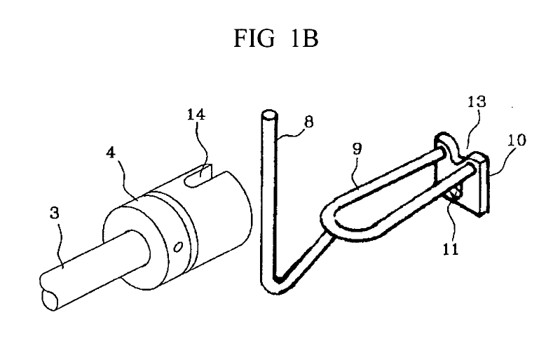

FIG. 1C is a view illustrating an operation state of an adaptor in a rotation of a rotational shaft;

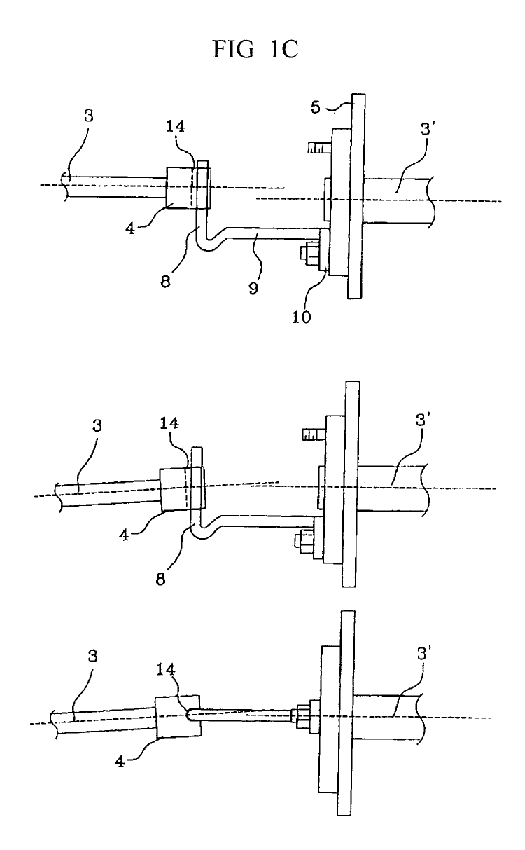

FIG. 2 is view illustrating a torque transferring apparatus of a disk brake lathe according to an embodiment of the present invention;

FIG. 3 is a side sectional view of the torque transferring apparatus according to an embodiment of the present invention; and

FIG. 4 is a view illustrating a torque transferring apparatus of a disk brake lathe according to another embodiment of the present invention, showing that a reinforcement rib is formed at a bracket.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

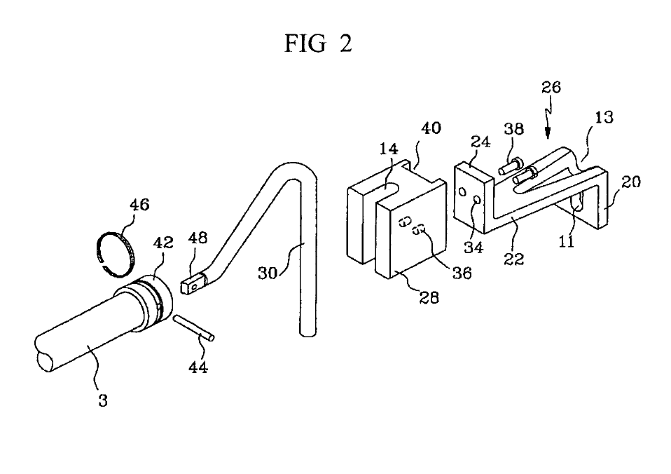

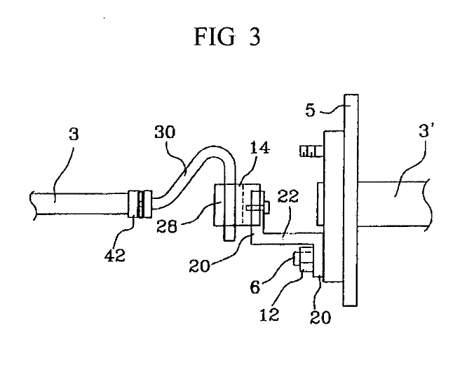

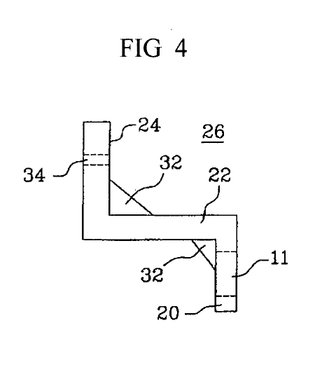

FIG. 2 is view illustrating a torque transferring apparatus of a disk brake lathe according to an embodiment of the present invention, and FIG. 3 is a side sectional view of the torque transferring apparatus according to an embodiment of the present invention. FIG. 4 is a view illustrating a torque transferring apparatus of a disk brake lathe according to another embodiment of the present invention, showing that a reinforcement rib is formed at a bracket.

A torque transferring apparatus of a disk brake lathe according to the present invention includes: an adaptor 4 installed in a rotational shaft 3 of a driving device, for transferring a torque from the driving device to a brake disk mounted on a vehicle; and a bracket 7 coupled to the adaptor 4 so that the bracket 7 is coupled to a bolt of the brake disk side. The bracket includes a flexible rod 8 inserted into a groove 14 of the adaptor 4, a coupling panel 10 coupled to the disk 5, and a coupling rod 9 horizontally coupled spaced apart from the coupling panel 10. In this embodiment, a coupling panel 20 is coupled to the disk 5, and an integral bracket 26 provides a separation position from the coupling panel 20. An adaptor 28 is coupled to the bracket 26 so that it is horizontally spaced apart from the coupling panel 20, and the adaptor 28 has a groove. A flexible rod 30 is coupled between the adaptor 28 and the rotational shaft 3, so that a torque is transferred from the rotational shaft 3.

The bracket 26 includes a separation panel 22 extended and bent from the coupling panel 20 to provide the separation distance, and an installation panel 24 extended and bent from the separation panel 22 in a central direction of the rotational shaft, such that the adaptor 28 approaches the rotational shaft. The separation panel 22 and the installation panel 24 are integrally formed.

According to another embodiment of the present invention, the bracket 26 includes a reinforcement rib 32 at a bent portion between the separation panel 22 and the coupling panel 20, and a bent portion between the separation panel 22 and the installation panel 24.

Meanwhile, the adaptor 28 is mounted on the installation panel 24 through a coupling hole of the installation panel 24. A nut hole 36 is formed at the adaptor 28, such that the adaptor 28 and the bracket 26 are coupled through the coupling hole 34, the nut hole 36 and the bolt 38. Also, in order to avoid a weight concentration toward the bolt 38 during the rotation of the adaptor 28, an installation groove 40 is formed at the adaptor 28. The installation panel 24 is inserted into the installation groove 40.

An insertion groove 42 is formed at the rotational shaft 3. The flexible rod 30 is coupled to the rotational shaft 3 through the insertion groove 42 by means of a pin 44 and a ring stopper 46.

In another embodiment, the flexible rod 30 is spline coupled to the insertion groove 42 of the rotational shaft 3 in order to avoid a weight concentration toward the pin 44.

The torque transferring apparatus according to the present invention is mechanically stable and can be easily manufactured. Also, parts can be conveniently replaced. The bracket is provided in an integral type.

That is, a mismatch of the rotational shaft is classified into a mismatch on a straight line and a twist on a shaft having a declination. The mismatch on the straight line is prevented since the flexible rod slides in a lateral directional from the groove of the adaptor. The twist on the shaft is divided into biaxial orientation and is prevented due to the rotational shaft's rotation and contact in front and rear directions of the opening of the groove.

For this purpose, the flexible rod 30 is formed in a rod shape, and the adaptor 28 provides a groove 14 that contacts with the flexible rod 30 and rotates spaced inside the adaptor 28. The adaptor 28 transfers the torque to the coupling panel 20. The present invention separates two members depending on the structural difference.

That is, the rod member and the panel member are separated, and the panel member manages the bracket 26. Accordingly, the flexible rod 30 provided as the rod member is mounted on the rotational shaft 3 of the driving device, and the bracket 26 providing a horizontal position spaced from the coupling panel 20 is integrally formed. The adaptor 28 is interposed between the bracket 26 and the flexible rod 30.

The bracket 26 includes the separation panel 22 extended and bent from the coupling panel 20 to provide the separation distance, and the installation panel 24 extended and bent from the separation panel 22, in which the separation panel 22 and the installation panel 24 are integrally formed.

Like the prior art, the coupling panel 20 is coupled to the disk 5 through the bolt 13 and the wheel nut 12. For this purpose, the coupling opening 11 and the groove 13 are formed.

Meanwhile, the installation panel 24 is bent in a direction opposite to the coupling panel 20 with reference to the separation panel 22, that is, in a central direction of the rotational shaft of the disk 5. It is aimed to match the adaptor 28 with the rotational shaft of the disk to the maximum.

The adaptor 28 and the installation panel 24 are coupled to each other through the coupling hole 34 of the installation panel 24, the nut hole 36 of the adaptor 28 and the bolt 38.

In addition, the installation groove 40 is formed at the adaptor 28, and the installation panel 24 is inserted into the installation groove 40. Thus, it is possible to prevent the weight concentration toward the bolt 38 during the rotation of the adaptor 28. The adaptor 28 and the bracket 26 manage the rotational weight.

Due to this coupling method, it is easy to assemble and disassemble the adaptor 28. Considering that the adaptor 28 is often replaced due to the repetitive friction and weight, the easiness of the assembly is provided.

Meanwhile, the bracket 26 may include that reinforcement rib 32 between the separation panel 22 and the coupling panel 20 and between the separation panel 22 and the installation panel 24 so as to reinforce the horizontal state of the coupling panel 20 and the installation panel 24.

The reinforcement rib 32 maintains the fixed state on a diagonal structure of the two bent panels. The reinforcement rib 32 may be separately manufactured and welded. Alternatively, after the reinforcement rib 32 is integrally formed on the bracket 26, the panel is bent and welded.

Although the formation of the reinforcement rib 32 requires an additional process, this process is simpler than the prior art.

That is, according to the prior art, the U-shaped connection rod, the flexible rod and the coupling panel can be welded while maintaining the horizontal state. However, according to the present invention, the reinforcement rib is additionally coupled to the bracket which is previously formed in the horizontal state. This process is very simple and easy.

According to the present invention, the coupling portion is removed such that a mechanical stiffness can be maintained. The manufacture is easy and the productivity can be secured.

The insertion groove 42 is formed at the rotational shaft 3, and the flexible rod 30 is installed in the insertion groove by means of the pin 44 and the ring stopper 46.

For this purpose, the pinhole is formed corresponding to the side of the insertion groove and the flexible rod. The pin 44 is inserted into the pinhole and then the ring stopper 46 is installed.

The ring stopper 46 is prevented from releasing from the pin 44 due to the rotation of the rotational shaft 3.

Meanwhile, when the rotational shaft 3 and the flexible rod 30 are coupled only by the pin 44, the rotational force of the rotational shaft is concentrated on the pin 44.

In order to prevent the weight from concentrating on the pin 44, the flexible rod 30 is spline coupled to the insertion groove 42 of the rotational shaft.

Since the spline coupling does not require the precise engagement. The pin may manage only the coupling of two members through polygonal female part and male part. For example, a rectangular section is formed at the insertion part of the flexible rod 30 and a rectangular groove engaged with the insertion part is formed. Then, they are coupled to each other.

The extended rotational surface of the brake disk is performed by the bracket 26.

Also, the flexible rod 30 provides a rotational surface matching with the extended rotational surface at the rotational shaft of the driving device.

Since the accurate matching of the rotational surface is not secured, the adaptor 28 mounted on the bracket 26 manages the flexible region.

As described above, the flexible rod is separated from the bracket and mounted on the rotational shaft, and the adaptor is mounted on the adaptor, thereby providing the integral bracket.

The stiffness of the bracket is increased and the mechanical reliability is secured. The manufacture is easy and the productivity is improved. Also, it is easy to replace the adaptor from the bracket.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A torque transferring apparatus of a disk brake lathe including: an adaptor 4 installed in a rotational shaft 3 of a driving device, for transferring a torque from the driving device to a brake disk mounted on a vehicle; and a bracket 7 coupled to the adaptor 4 so that the bracket 7 is coupled to a bolt of the brake disk side, the bracket including a flexible rod 8 inserted into a groove 14 of the adaptor 4, a coupling panel 10 coupled to the disk 5, and a coupling rod 9 horizontally coupled spaced apart from the coupling panel 10, the apparatus comprising:
a coupling panel 20 coupled to the disk 5;
an integral bracket 26 providing a separation position from the coupling panel 20;
an adaptor 28 coupled to the bracket 26, such that the adaptor is horizontally spaced apart from the coupling panel 20, the adaptor 28 having a groove; and
a flexible rod 30 coupled between the adaptor 28 and the rotational shaft 3, such that a torque is transferred from the rotational shaft 3.

2. The torque transferring apparatus of claim 1, wherein the bracket 26 includes:
a separation panel 22 extended and bent from the coupling panel 20 to provide the separation distance; and
an installation panel 24 extended and bent from the separation panel 22 in a central direction of the rotational shaft, such that the adaptor 28 approaches the rotational shaft, the separation panel 22 and the installation panel 24 being integrally formed.

3. The torque transferring apparatus of claim 2, wherein the bracket 26 includes a reinforcement rib 32 at a bent portion between the separation panel 22 and the coupling panel 20, and a bent portion between the separation panel 22 and the installation panel 24.

4. The torque transferring apparatus of claim 1, wherein the adaptor 28 includes an installation groove 40 into which an installation panel 24 of the bracket 26 is inserted, a coupling hole 34 is formed at the installation panel 24 and a nut hole 36 is formed at the adaptor 28, such that the adaptor 28 and the bracket 26 are coupled through the coupling hole 34, the nut hole 36 and a bolt 38.

5. The torque transferring apparatus of claim 1, wherein the rotational shaft 3 has an insertion groove 42, and the flexible rod 30 is installed in the rotational shaft 3 through an insertion groove 42 by means of a pin 44 and a ring stopper 46.

6. The torque transferring apparatus of claim 5, wherein the flexible rod 30 is spline coupled to the insertion groove of the rotational shaft 3 in order to prevent a weight concentration toward the pin 44.
